(19) United States
(12) Patent Application Publication
(10) Pub. No.: US 2026/0211530 A1
(43) Pub. Date: Jul. 23, 2026

(54) INPUT DEVICE

(71) Applicant: ALPS ALPINE CO., LTD., Tokyo (JP)

(72) Inventor: Tetsuo MURANAKA, Miyagi (JP)

(21) Appl. No.: 19/570,729

(22) Filed: Mar. 18, 2026

Related U.S. Application Data
(63) Continuation of application No. PCT/JP2024/030099, filed on Aug. 23, 2024.

(30) Foreign Application Priority Data
Oct. 5, 2023 (JP) 2023-173868

(51) Int. Cl. G06F 3/044; A63F 13/218

(52) U.S. Cl. CPC G06F 3/0446; A63F 13/218

(57) ABSTRACT

An input device includes a load sensor, an electrostatic sensor, and a measurement circuit, wherein the load sensor includes a first voltage dividing circuit including a first strain sensor and a second strain sensor connected in series, and a first capacitor having one end connected to a connection point between the first strain sensor and the second strain sensor, the electrostatic sensor has a plurality of electrostatic sensor electrodes, and the measurement circuit includes an AC voltage circuit configured to apply an AC voltage to the first voltage dividing circuit and the electrostatic sensor electrodes, at least one charge amplifier provided downstream of the first capacitor and the plurality of electrostatic sensor electrodes, and a control circuit configured to calculate a measured value from an output of the charge amplifier.

### CROSS-REFERENCE TO RELATED APPLICATIONS

The present application is a continuation of International Application PCT/JP2024/030099, filed on Aug. 23, 2024 and designated the U.S., which is based on and claims priority to Japanese Patent Application No. 2023-173868 filed on Oct. 5, 2023, with the Japan Patent Office. The entire contents of these applications are incorporated herein by reference.

### FIELD OF THE INVENTION

The present disclosure relates to input devices.

### BACKGROUND OF THE INVENTION

Conventionally, there has been a multi-directional input device comprising a mounting plate, an elastic substrate placed on the mounting plate, a plurality of strain detecting members formed on the elastic substrate, and an operating body for operating the strain detecting members, characterized in that the mounting plate and the elastic substrate are fixed at a welded portion (see, for example, Patent Document 1).

While conventional multi-directional input devices can detect a load applied to an operating body based on strain, they cannot detect capacitance. Consequently, it is impossible to measure both a load based on strain and capacitance with a single measurement circuit.

There may be a need to provide an input device capable of measuring both a load based on strain and capacitance with a single measurement circuit.

### RELATED-ART DOCUMENT

### Patent Document

[Patent Document 1] Japanese Patent Laid-open Publication No. 10-049293

### SUMMARY OF THE INVENTION

According to an embodiment, an input device includes a load sensor, an electrostatic sensor, and a measurement circuit, wherein the load sensor includes a first voltage dividing circuit including a first strain sensor and a second strain sensor connected in series, and a first capacitor having one end connected to a connection point between the first strain sensor and the second strain sensor, the electrostatic sensor has a plurality of electrostatic sensor electrodes, and the measurement circuit includes an AC voltage circuit configured to apply an AC voltage to the first voltage dividing circuit and the electrostatic sensor electrodes, at least one charge amplifier provided downstream of the first capacitor and the plurality of electrostatic sensor electrodes, and a control circuit configured to calculate a measured value from an output of the charge amplifier.

According to at least one embodiment, it is possible to provide an input device capable of measuring both a load based on strain and capacitance with a single measurement circuit.

### BRIEF DESCRIPTION OF THE DRAWINGS

FIG. 1 is a diagram showing an example of the configuration of an input device according to an embodiment;

FIG. 2A is a diagram showing an example of a circuit configuration of the input device according to the embodiment;

FIG. 2B is a diagram showing an example of a configuration of an input device according to a modification of the embodiment; and

FIG. 2C is a diagram showing an example of a configuration of an input device according to another modification of the embodiment.

### DESCRIPTION OF THE PREFERRED EMBODIMENTS

Embodiments to which the input device of the present disclosure is applied will be described below.

In the following description, an XYZ coordinate system is defined. The direction parallel to the X-axis (X-direction), the direction parallel to the Y-axis (Y-direction), and the direction parallel to the Z-axis (Z-direction) are orthogonal to each other. Further, “plan view” refers to viewing from above the XY plane. In addition, the length, thickness, width, etc., of each part may be exaggerated in the drawings to make the configuration easier to understand.

### Embodiment

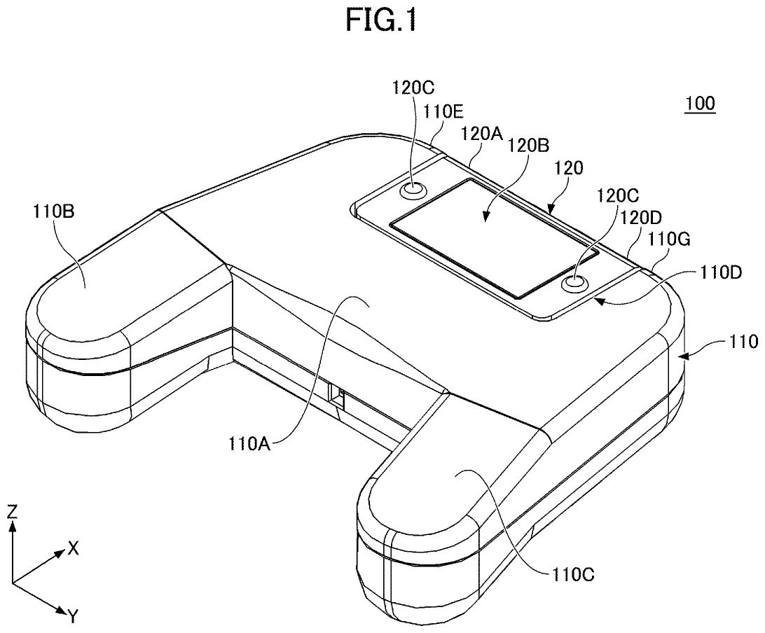

FIG. 1 is a diagram showing an example of the configuration of an input device 100 according to an embodiment. The input device 100 is, as an example, a game machine for personal use, but it may also be a PC (Personal Computer), a tablet-type input device placed in stores or facilities for use by a number of unspecified users, or an input unit of an ATM (Automatic Teller Machine).

### Overview of Input Device 100

FIG. 1 is an external perspective view of the input device 100 according to one embodiment. The input device 100 shown in FIG. 1 is used, for example, in a game machine and is operated by an operator (i.e., a game player).

As shown in FIG. 1, the input device 100 includes a housing 110. The housing 110 is a resin member that forms the outer shape of the input device 100. Inside the housing 110, a strain body is provided that deforms when an operation (tilting operation, rotating operation, and pressing operation) of a touchpad unit 120 is performed.

The housing 110 has a center portion 110A, a left grip portion 110B provided on the left side (Y-axis negative side) of the center portion 110A, and a right grip portion 110C provided on the right side (Y-axis positive side) of the center portion 110A. The left grip portion 110B and the right grip portion 110C are longer than the center portion 110A in the front-rear direction (X-axis direction) and have a shape that protrudes rearward (X-axis negative direction) from the rear surface of the center portion 110A.

With this arrangement, the housing 110 has a shape that makes it easy for the operator to grip the left grip portion 110B with the left hand and the right grip portion 110C with the right hand.

Further, at the front end (X-axis positive side end) of the center portion 110A of the housing 110, a recess 110D is formed which is recessed downward (Z-axis negative direction) from the upper surface 110E of the housing. The input device 100 includes the touchpad unit 120 within the recess 110D of the housing 110. The touchpad unit 120 is an example of an electrostatic sensor.

In a plan view from above (Z-axis positive direction), both the recess 110D and the touchpad unit 120 have a rectangular shape with the longitudinal direction being the left-right direction (Y-axis direction). The rectangular shape formed by the touchpad unit 120 is smaller than the rectangular shape formed by the recess 110D. Thus, a gap is provided between the outer periphery of the touchpad unit 120 and the inner periphery of the recess 110D.

Furthermore, the upper surface 110E (Z-axis positive side surface) of the housing 110 and the upper surface 120A (Z-axis positive side surface) of the touchpad unit 120 are provided on the same plane.

The touchpad unit 120 has a rectangular touch operation surface 120B on its upper surface 120A (Z-axis positive side surface), with its longitudinal direction being the left-right direction (Y-axis direction). The touchpad unit 120 allows the operator to perform touch operations on the touch operation surface 120B.

Further, the touchpad unit 120 is provided so as to be displaceable relative to the housing 110, allowing the operator to perform pressing operations, tilting operations, and rotating operations.

The pressing operation of the touchpad unit 120 refers to an operation of pressing the center portion of the touch operation surface 120B of the touchpad unit 120 downward (Z-axis negative direction). By the pressing operation, a compressive load is applied to the touchpad unit 120 downward (Z-axis negative direction) while remaining in a horizontal state.

The tilting operation of the touchpad unit 120 refers to an operation of pressing a peripheral portion (a portion other than the center portion) of the touch operation surface 120B of the touchpad unit 120 downward (Z-axis negative direction). By the tilting operation, a bending load is applied to the touchpad unit 120 relative to a central axis passing through the center of the touchpad unit 120 (a central axis parallel to the Z-axis).

The rotating operation of the touchpad unit 120 refers to an operation of twisting the touchpad unit 120 around a central axis passing through the center of the touchpad unit 120 (a central axis parallel to the Z-axis). By the rotating operation, a torsional load is applied to the touchpad unit 120 around the central axis passing through the center of the touchpad unit 120 (a central axis parallel to the Z-axis).

In addition to the touchpad unit 120, the input device 100 may be equipped with other input devices such as a plurality of buttons and analog sticks. Further, the input device 100 may be a device operated by tilting a stick.

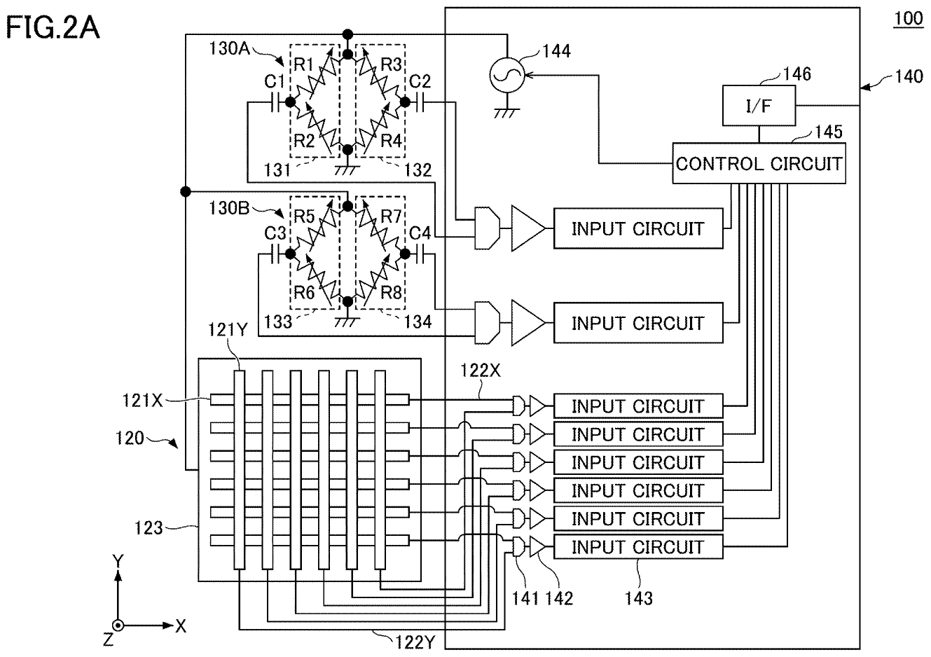

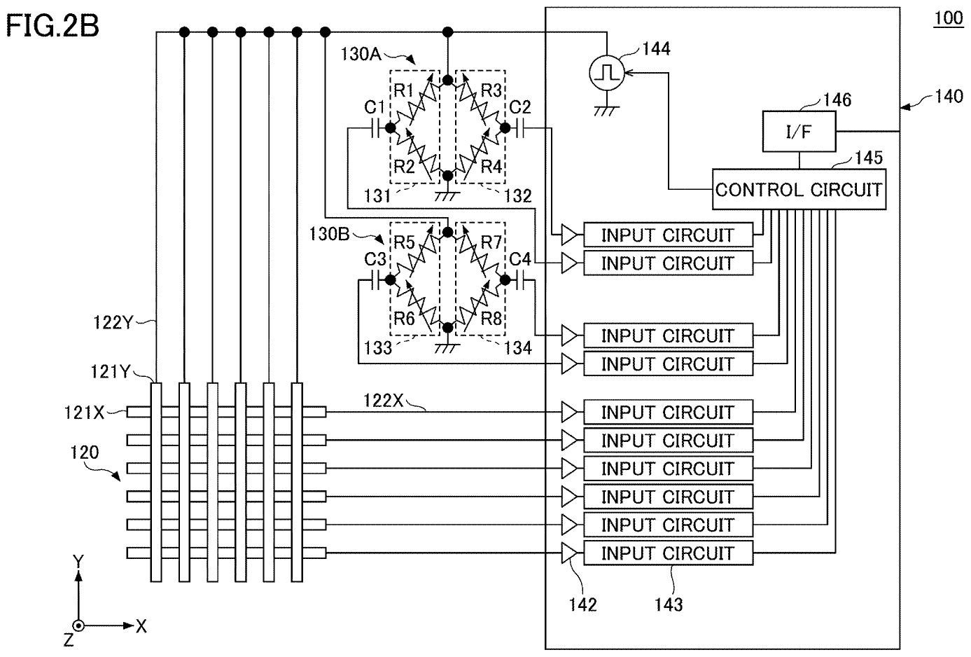

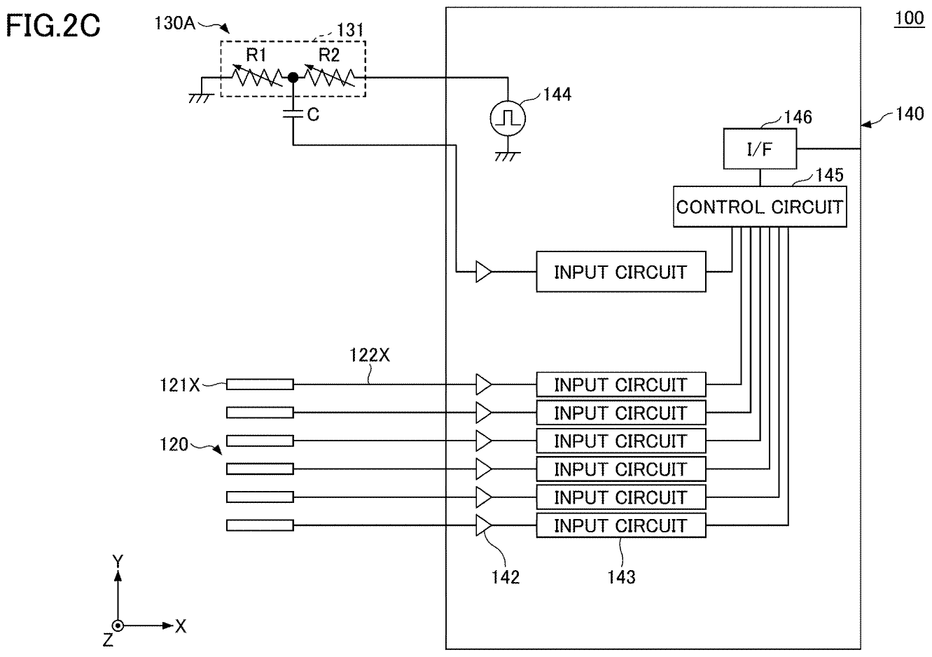

FIG. 2A is a diagram showing an example of a circuit configuration of the input device 100 according to the embodiment. The input device 100 includes the touchpad unit 120, load sensors 130A and 130B, and a measurement circuit 140.

The load sensors 130A and 130B are attached to the strain body provided inside the housing 110. The strain body deforms when the touchpad unit 120 is operated (tilting operation, rotating operation, and pressing operation).

As an example, the input device 100 is capable of measuring the operation amount of tilting and pressing operations based on the output of the load sensor 130A, and measuring the operation amount of rotating operations based on the output of the load sensor 130B. The configurations of the touchpad unit 120, the load sensors 130A and 130B, and the measurement circuit 140 will be described below.

### Touchpad Unit 120

The touchpad unit 120 includes a plurality of sensor electrodes 121X extending in the X direction, a plurality of sensor electrodes 121Y extending in the Y direction, wirings 122X and 122Y, and an active shield electrode 123. The sensor electrodes 121X and 121Y are examples of electrostatic sensor electrodes and are respectively connected to MUXs 141 of the measurement circuit 140 via the wirings 122X and 122Y. The sensor electrodes 121X and 121Y are arranged overlapping on the +Z direction side of the active shield electrode 123 and are insulated from the active shield electrode 123. The touchpad unit 120 shown in FIG. 2A is a self-capacitance type electrostatic sensor.

The sensor electrodes 121X, 121Y and the wirings 122X, 122Y can be produced, for example, by forming a conductive film such as a metal film on the surface of an insulating substrate and patterning it into the sensor electrodes 121X, 121Y and the wirings 122X, 122Y. Further, the active shield electrode 123 can be produced by forming a conductive film such as a metal film on the surface of another insulating substrate. Note that when a display is arranged on the −Z direction side of the touchpad unit 120, a transparent glass plate or the like may be used as the insulating substrate, and a transparent conductive film such as ITO (Indium Tin Oxide) may be used as the conductor film.

The plurality of sensor electrodes 121X are scanned row by row, while the plurality of sensor electrodes 121Y are scanned column by column, and the control circuit 145 converts the capacitance at a plurality of intersections between the plurality of sensor electrodes 121X and the plurality of sensor electrodes 121Y into digital values. Note that instead of the sensor electrodes 121X and 121Y, a plurality of sensor electrodes arranged in a two-dimensional array may be used and scanned in order.

The active shield electrode 123 is formed without gaps over an area larger than the portion where the sensor electrodes 121X and 121Y are provided. The active shield electrode 123 is connected to an AC signal source 144 and is driven by an AC signal having the same frequency and phase as the AC component included in the signals supplied to the sensor electrodes 121X and 121Y. The amplitude of the AC signal supplied to the active shield electrode 123 is larger than the amplitude of the AC component of the signals supplied to the sensor electrodes 121X and 121Y.

The active shield electrode 123 is provided to shield the plurality of sensor electrodes 121X and 121Y from noise and to suppress the influence of parasitic capacitance. The active shield electrode 123 is arranged close to and overlapping the plurality of sensor electrodes 121X and 121Y with a predetermined interval so that it can shield the sensor electrodes 121X and 121Y mainly from noise from a ground potential point such as the ground, and can suppress the influence of parasitic capacitance between the sensor electrodes and the ground potential point.

The input device 100 may be configured without the touchpad unit 120.

### Load Sensor 130A

The load sensor 130A includes a voltage dividing circuit 131 including strain sensors R1 and R2, a voltage dividing circuit 132 including strain sensors R3 and R4, a capacitor C1, and a capacitor C2. The voltage dividing circuit 131 is an example of a first voltage dividing circuit, and the voltage dividing circuit 132 is an example of a second voltage dividing circuit. The strain sensors R1 to R4 are examples of first to fourth strain sensors, respectively. The capacitor C1 is an example of a first capacitor, and the capacitor C2 is an example of a second capacitor.

The strain sensors R1 to R4 are, for example, strain resistance elements whose resistance values change according to the amount of strain, and are connected to form a bridge circuit. The capacitor C1 is connected to the connection point of the strain sensors R1 and R2, and the capacitor C2 is connected to the connection point of the strain sensors R3 and R4.

The strain sensors R1 and R3 are connected to the AC signal source 144, and the strain sensors R2 and R4 are connected to ground. The capacitors C1 and C2 are connected to the input terminals of a MUX (multiplexer) 141.

### Load Sensor 130B

The load sensor 130B includes a voltage dividing circuit 133 including strain sensors R5 and R6, a voltage dividing circuit 134 including strain sensors R7 and R8, a capacitor C3, and a capacitor C4. The voltage dividing circuit 133 is an example of a third voltage dividing circuit, and the voltage dividing circuit 134 is an example of a fourth voltage dividing circuit. The strain sensors R5 to R8 are examples of fifth to eighth strain sensors, respectively. The capacitor C3 is an example of a third capacitor, and the capacitor C4 is an example of a fourth capacitor.

The strain sensors R5 to R8 are, for example, strain resistance elements whose resistance values change according to the amount of strain, and are connected to form a bridge circuit. The capacitor C3 is connected to the connection point of the strain sensors R5 and R6, and the capacitor C4 is connected to the connection point of the strain sensors R7 and R8.

The strain sensors R5 and R7 are connected to the AC signal source 144, and the strain sensors R6 and R8 are connected to ground. The capacitors C3 and C4 are connected to the input terminals of a MUX (multiplexer) 141.

It may suffice for the input device 100 to be configured to include only one of the load sensors 130A and 130B.

### Measurement Circuit 140

The measurement circuit 140 includes the MUXs 141, charge amplifiers 142, input circuits 143, an AC signal source 144, a control circuit 145, and an I/F (Interface) 146. The AC signal source 144 is an example of an AC voltage circuit. The measurement circuit 140 is implemented as an IC (Integrated Circuit).

The measurement circuit 140 is, as an example, an IC designed and developed for the touchpad unit 120, and is realized as a single packaged IC chip. The MUXs 141, charge amplifiers 142, input circuits 143, AC signal source 144, control circuit 145, and I/F 146 are built into the measurement circuit 140 composed of the IC chip.

The input device 100 measures capacitance through the touchpad unit 120 and measures load through the load sensors 130A and 130B including the strain sensors R1 to R8, using the measurement circuit 140 for the touchpad unit 120.

In order to measure the load with the measurement circuit 140 designed and developed for the touchpad unit 120, the capacitors C1 to C4 for converting changes in the resistance values of the strain sensors R1 to R8 into changes in charge amount are provided in the load sensors 130A and 130B. By converting the changes in the resistance values of the strain sensors R1 to R8 into changes in charge amount, it becomes possible to measure the changes in the resistance values of the strain sensors R1 to R8 without making changes to the measurement circuit 140 for the touchpad unit 120.

### MUX 141

The MUXs 141 are located downstream (i.e., at the output side) of the capacitors C1 to C4 and all the sensor electrodes 121X and 121Y. More specifically, the capacitors C1 and C2 are connected to two input terminals of a common MUX 141. The capacitors C3 and C4 are connected to two input terminals of a common MUX 141. Further, the sensor electrodes 121X and 121Y are provided in the same number, and each one is connected to two input terminals of a common MUX 141.

### Charge Amplifier 142

The charge amplifiers 142 are equal in number to the MUXs 141, and one charge amplifier 142 is connected to the output side of each MUX 141. The charge amplifier 142 connected to the capacitors C1 and C2 via the MUX 141 outputs a signal representing the charge amount of the capacitors C1 and C2. The charge amplifier 142 connected to the capacitors C3 and C4 via the MUX 141 outputs a signal representing the charge amount of the capacitors C3 and C4. The charge amplifier 142 connected to the sensor electrodes 121X and 121Y via the MUX 141 outputs a signal representing the charge amount of the sensor electrodes 121X and 121Y.

Although FIG. 2A shows a circuit configuration in which one charge amplifier 142 is connected to the output side of each MUX 141, a configuration may be adopted in which one common multiplexer (MUX) is provided on the output side of all MUXs 141, and one input circuit 143 is connected via one charge amplifier 142 to the output side of this MUX.

### Input Circuit 143

The input circuits 143 are equal in number to the charge amplifiers 142, and one is connected to the output side of each charge amplifier 142. The input circuit 143 performs digital conversion processing or the like on the signal output from the charge amplifier 142 and outputs it to the control circuit 145.

### AC Signal Source 144

The AC signal source 144 is connected to the strain sensors R1, R3, R5, R7 and the active shield electrode 123. The AC signal source 144 generates a sinusoidal AC signal to be applied to the strain sensors R1 to R8 and the active shield electrode 123. Further, the control circuit 145 supplies the sensor electrodes 121X and 121Y with a signal containing an AC component that has the same frequency and phase as the AC signal supplied to the active shield electrode 123 but has a smaller amplitude than the AC signal supplied to the active shield electrode 123. Since the AC signal source 144 only needs to output an AC signal, it may be configured to output, for example, a rectangular wave AC signal.

### Control Circuit 145

The control circuit 145 is realized by a computer including a CPU, RAM (Random Access Memory), ROM (Read Only Memory), an input/output interface, and an internal bus. As the control circuit 145, an MPU (Micro Processing Unit) may be used as an example.

The control circuit 145 is connected to all the input circuits 143 and the AC signal source 144. The control circuit 145 has a multiplexer function that combines a plurality of signals input from the input circuits 143 connected to all the sensor electrodes 121X and 121Y into one signal.

The control circuit 145 performs drive control of the AC signal source 144, measurement of load based on signals input from the input circuits 143 connected to the voltage dividing circuits 131 through 134, and measurement of coordinates based on signals input from the input circuits 143 connected to the sensor electrodes 121X and 121Y. The measurement of coordinates is directed to the position of an operating body such as a fingertip relative to the operation surface.

### Modification of Input Device 100

FIG. 2B is a diagram showing an example of the configuration of an input device 100 according to a modification of the embodiment. The input device 100 shown in FIG. 2B differs from the input device 100 shown in FIG. 2A in that the touchpad unit 120 is of a mutual capacitance type.

### Touchpad Unit 120

The touchpad unit 120 includes a plurality of sensor electrodes 121X extending in the X direction, a plurality of sensor electrodes 121Y extending in the Y direction, and wirings 122X and 122Y, but does not include the active shield electrode 123.

The sensor electrodes 121X and 121Y are examples of electrostatic sensor electrodes. The sensor electrodes 121X are connected to the charge amplifiers 142 via the wirings 122X, and the sensor electrodes 121Y are connected to the AC signal source 144 via the wirings 122Y.

The plurality of sensor electrodes 121X are scanned row by row while the plurality of sensor electrodes 121Y are scanned column by column, and the control circuit 145 converts the capacitance at the plurality of intersections between the plurality of sensor electrodes 121X and the plurality of sensor electrodes 121Y into digital values. Note that instead of the sensor electrodes 121X and 121Y, a plurality of sensor electrodes arranged in a two-dimensional array may be used and scanned in order.

### Load Sensors 130A, 130B

The configurations of the load sensors 130A and 130B are the same as those of the load sensors 130A and 130B of the input device 100 shown in FIG. 2A.

### Measurement Circuit 140

The measurement circuit 140 includes the charge amplifiers 142, the input circuits 143, the AC signal source 144, the control circuit 145, and the I/F 146, but does not include the MUXs 141.

### Charge Amplifier 142

Among all the charge amplifiers 142, four charge amplifiers 142 are connected in one-to-one correspondence to the capacitors C1 to C4, different from the configuration shown in FIG. 2A. To each of the remaining charge amplifiers 142, one sensor electrode 121X is connected.

Further, the input circuit 143 is the same as the input circuit 143 shown in FIG. 2A. The AC signal source 144 is connected to the strain sensors R1, R3, R5, R7 and all the sensor electrodes 121Y.

The AC signal source 144 in the input device 100 shown in FIG. 2B outputs, for example, a rectangular wave AC signal. However, the AC signal source 144 may be configured to output a sinusoidal AC signal.

The control circuit 145 is the same as the control circuit 145 shown in FIG. 2A in that it is connected to all input circuits 143 and the AC signal source 144, but differs from the control circuit 145 shown in FIG. 2A in that it has a multiplexer function to combine a plurality of signals input from the plurality of input circuits 143 connected to all the sensor electrodes 121X into one signal.

The control circuit 145 performs drive control of the AC signal source 144, measurement of load based on signals input from the input circuits 143 connected to the voltage dividing circuits 131 through 134, and measurement of coordinates based on signals input from the input circuits 143 connected to the sensor electrodes 121X.

Whether the circuit configuration of the input device 100 is that of FIG. 2A or FIG. 2B, the capacitance can be measured through the touchpad unit 120 and the load can be measured through the load sensors 130A and 130B including the strain sensors R1 to R8 using the measurement circuit 140 for the touchpad unit 120.

By providing the capacitors C1 to C4 for converting changes in the resistance values of the strain sensors R1 to R8 into changes in charge amount in the load sensors 130A and 130B and converting the changes in resistance values into changes in charge amount, it becomes possible to measure changes in the resistance values of the strain sensors R1 to R8 without making changes to the measurement circuit 140 for the touchpad unit 120. With this arrangement, measurement of the load of tilting, rotating, and pressing operations by the load sensors 130A and 130B can be performed with the measurement circuit 140 for the touchpad unit 120.

### Another Modification of Input Device 100

FIG. 2C is a diagram showing an example of the configuration of an input device 100 according to another modification of the embodiment. The input device 100 shown in FIG. 2C differs from the input device 100 shown in FIG. 2A in that the touchpad unit 120 includes a plurality of sensor electrodes 121X extending in the X direction and wirings 122X, but does not include either the plurality of sensor electrodes 121Y extending in the Y direction or the wirings 122Y. Note that the touchpad unit 120 shown in FIG. 2C may include an active shield electrode 123.

Further, the input device 100 shown in FIG. 2C differs from the input device 100 shown in FIG. 2A in that it includes one load sensor 130A and does not include the load sensor 130B. Furthermore, the load sensor 130A differs from the input device 100 shown in FIG. 2A in that it includes one voltage dividing circuit 131 and does not include the voltage dividing circuit 132. The voltage dividing circuit 131 of the input device 100 shown in FIG. 2C has two strain sensors R1 and R2.

In addition, the input device 100 shown in FIG. 2C differs from the input device 100 shown in FIG. 2A in that it does not include the MUXs 141, and the capacitor connected to the connection point of the strain sensors R1 and R2 is directly connected to a charge amplifier 142 while the charge amplifier 142 is directly connected to the input circuit 143.

In the input device 100 shown in FIG. 2C, Y-direction coordinates can be detected with the plurality of sensor electrodes 121X. For example, when the load sensor 130A is provided under the touchpad unit 120, the load (pressing operation amount) applied to the touchpad unit 120 can be measured based on the output of the load sensor 130A. Further, when the load sensor 130A is made capable of detecting load in the X direction, the input device 100 shown in FIG. 2C can detect both an operation of moving a finger in the Y direction and an operation of pushing with a finger in the X direction.

### Effects

The input device 100 includes the load sensor 130A, the touchpad unit 120 (electrostatic sensor), and the measurement circuit 140. The load sensor 130A has the voltage dividing circuit 131 including the strain sensor R1 and the strain sensor R2 connected in series, and the capacitor C1 having one end connected to the connection point between the strain sensor R1 and the strain sensor R2. The touchpad unit 120 has the plurality of sensor electrodes 121X. The measurement circuit 140 has the AC signal source 144 configured to apply an AC voltage to the voltage dividing circuit 131 and the sensor electrodes 121X, at least one charge amplifier 142 provided downstream of the capacitor C1 and the plurality of sensor electrodes 121X, and the control circuit 145 configured to calculate a measured value from the output of the charge amplifier 142.

By providing the capacitor C1 for converting changes in the resistance values of the strain sensors R1 to R2 into changes in charge amount in the load sensor 130A and converting the changes in resistance values into changes in charge amount, it becomes possible to measure changes in the resistance values of the strain sensors R1 to R2 without making changes to the measurement circuit 140 for the touchpad unit 120. With this arrangement, measurement of coordinates by the touchpad unit 120 and measurement of load by the load sensor 130A during operation can be performed with one measurement circuit 140.

Therefore, it is possible to provide the input device 100 capable of measuring both a load based on strain and capacitance with one measurement circuit 140.

Further, the load sensor 130A may further include the voltage dividing circuit 132 including the strain sensor R3 and the strain sensor R4 connected in series, and the capacitor C2 having one end connected to the connection point between the strain sensor R3 and the strain sensor R4. The measurement circuit 140 may further include a charge amplifier 142 provided downstream of the capacitor C2, and the AC signal source 144 may further apply an AC voltage to the voltage dividing circuit 132.

By providing the capacitors C1 and C2 for converting changes in the resistance values of the strain sensors R1 to R4 into changes in charge amount in the load sensor 130A and converting the changes in resistance values into changes in charge amount, it becomes possible to measure changes in the resistance values of the strain sensors R1 to R4 without making changes to the measurement circuit 140 for the touchpad unit 120. With this arrangement, measurement of coordinates by the touchpad unit 120 and measurement of load during operation by the load sensor 130A can be performed with one measurement circuit 140.

Accordingly, it is possible to provide the input device 100 capable of measuring both a load based on strain and capacitance with one measurement circuit 140.

The input device 100 includes the load sensor 130A and the measurement circuit 140. The load sensor 130A has the voltage dividing circuit 131 including the strain sensor R1 and the strain sensor R2 connected in series, and the capacitor C1 having one end connected to the connection point between the strain sensor R1 and the strain sensor R2. The measurement circuit 140 has the AC signal source 144 configured to apply an AC voltage to the voltage dividing circuit 131, the charge amplifier 142 provided downstream of the capacitor C1, and the control circuit 145 configured to calculate a measured value from the output of the charge amplifier 142.

By providing the capacitor C1 for converting changes in the resistance values of the strain sensors R1 to R2 into changes in charge amount in the load sensor 130A and converting the changes in resistance values into changes in charge amount, it becomes possible to measure changes in the resistance values of the strain sensors R1 to R2 without making changes to the measurement circuit 140 for the touchpad unit 120. With this arrangement, measurement of load during operation by the load sensor 130A can be performed with the measurement circuit 140 for the touchpad unit 120.

Accordingly, it is possible to provide the input device 100 capable of measuring a load based on strain with the measurement circuit 140 for the touchpad unit 120.

Moreover, the load sensor 130A may further include the voltage dividing circuit 132 including the strain sensor R3 and the strain sensor R4 connected in series, and the capacitor C2 having one end connected to the connection point between the strain sensor R3 and the strain sensor R4. The measurement circuit 140 may further include a charge amplifier 142 provided downstream of the capacitor C2, and the AC signal source 144 may further apply an AC voltage to the voltage dividing circuit 132.

By providing the capacitors C1 and C2 for converting changes in the resistance values of the strain sensors R1 to R4 into changes in charge amount in the load sensor 130A and converting the changes in resistance values into changes in charge amount, it becomes possible to measure changes in the resistance values of the strain sensors R1 to R4 without making changes to the measurement circuit 140 for the touchpad unit 120. With this arrangement, measurement of coordinates by the touchpad unit 120 and measurement of load during operation by the load sensor 130A can be performed with one measurement circuit 140.

Accordingly, it is possible to provide the input device 100 capable of measuring both a load based on strain and capacitance with one measurement circuit 140.

Further, the measurement circuit 140 may be composed of an IC capable of detecting the capacitance of the touchpad unit 120, and the AC signal source 144 and the charge amplifiers 142 may be built into the IC. By not using an IC dedicated to strain sensors, the types of ICs are reduced, making inventory management easier. Also, if an IC for the touchpad unit 120 already exists, IC design costs become unnecessary. Furthermore, the development period can be shortened in proportion to the eliminated IC design phase.

Further, the load sensors 130A and 130B may further include the voltage dividing circuit 133 including the strain sensor R5 and the strain sensor R6 connected in series, the capacitor C3 having one end connected to the connection point between the strain sensor R5 and the strain sensor R6, the voltage dividing circuit 134 including the strain sensor R7 and the strain sensor R8 connected in series, the capacitor C4 having one end connected to the connection point between the strain sensor R7 and the strain sensor R8, and charge amplifiers 142 each provided downstream of a corresponding one of the capacitor C3 and the capacitor C4. The control circuit 145 may detect a load in a first direction from the output of the charge amplifier 142 receiving the output of the voltage dividing circuit 131, detect a load in a second direction from the output of the charge amplifier 142 receiving the output of the voltage dividing circuit 132, detect a load in a first rotating direction from the output of the charge amplifier 142 receiving the output of the voltage dividing circuit 133, and detect a load in a second rotating direction from the output of the charge amplifier 142 receiving the output of the voltage dividing circuit 134.

By providing the capacitors C1 to C4 for converting changes in the resistance values of the strain sensors R1 to R8 into changes in charge amount in the load sensors 130A and 130B and converting the changes in resistance values into changes in charge amount, it becomes possible to measure changes in the resistance values of the strain sensors R1 to R8 without making changes to the measurement circuit 140 for the touchpad unit 120. With this arrangement, measurement of the load of tilting, rotating, and pressing operations by the load sensors 130A and 130B can be performed with the measurement circuit 140 for the touchpad unit 120.

While the input device of the exemplary embodiments of the present disclosure has been described above, the present disclosure is not limited to the specifically disclosed embodiments, and various modifications and changes can be made without departing from the scope of the claims.

What is claimed is:

1. An input device comprising:
a load sensor;
an electrostatic sensor; and
a measurement circuit,
wherein the load sensor includes:
a first voltage dividing circuit including a first strain sensor and a second strain sensor connected in series; and
a first capacitor having one end connected to a connection point between the first strain sensor and the second strain sensor,
the electrostatic sensor has a plurality of electrostatic sensor electrodes, and
the measurement circuit includes:
an AC voltage circuit configured to apply an AC voltage to the first voltage dividing circuit and the electrostatic sensor electrodes;
at least one charge amplifier provided downstream of the first capacitor and the plurality of electrostatic sensor electrodes; and
a control circuit configured to calculate a measured value from an output of the charge amplifier.

2. The input device according to claim 1, wherein the load sensor further includes:
a second voltage dividing circuit including a third strain sensor and a fourth strain sensor connected in series; and
a second capacitor having one end connected to a connection point between the third strain sensor and the fourth strain sensor,
wherein the measurement circuit further includes a charge amplifier provided downstream of the second capacitor, and the AC voltage circuit further applies an AC voltage to the second voltage dividing circuit.

3. An input device comprising:
a load sensor; and
a measurement circuit,
wherein the load sensor includes:
a first voltage dividing circuit including a first strain sensor and a second strain sensor connected in series; and
a first capacitor having one end connected to a connection point between the first strain sensor and the second strain sensor,
the measurement circuit includes:
an AC voltage circuit configured to apply an AC voltage to the first voltage dividing circuit;
a charge amplifier provided downstream of the first capacitor; and
a control circuit configured to calculate a measured value from an output of the charge amplifier.

4. The input device according to claim 3, wherein the load sensor further includes:
a second voltage dividing circuit including a third strain sensor and a fourth strain sensor connected in series; and
a second capacitor having one end connected to a connection point between the third strain sensor and the fourth strain sensor,
wherein the measurement circuit further includes a charge amplifier provided downstream of the second capacitor, and the AC voltage circuit further applies the AC voltage to the second voltage dividing circuit.

5. The input device according to claim 1, wherein the measurement circuit is composed of an IC configured to detect a capacitance of an electrostatic sensor, and the AC voltage circuit and the charge amplifier are built into the IC.

6. The input device according to claim 2, wherein the load sensor further includes:
a third voltage dividing circuit including a fifth strain sensor and a sixth strain sensor connected in series;
a third capacitor having one end connected to a connection point between the fifth strain sensor and the sixth strain sensor;
a fourth voltage dividing circuit including a seventh strain sensor and an eighth strain sensor connected in series;
a fourth capacitor having one end connected to a connection point between the seventh strain sensor and the eighth strain sensor; and
charge amplifiers each provided downstream of a corresponding one of the third capacitor and the fourth capacitor,
wherein the control circuit is configured to:
detect a load in a first direction from an output of the charge amplifier receiving an output of the first voltage dividing circuit;
detect a load in a second direction from an output of the charge amplifier receiving an output of the second voltage dividing circuit;
detect a load in a first rotating direction from an output of the charge amplifier receiving an output of the third voltage dividing circuit; and
detect a load in a second rotating direction from an output of the charge amplifier receiving an output of the fourth voltage dividing circuit.
